(19) United States
(12) Patent Application Publication
(10) Pub. No.: US 2009/0068560 A1
(43) Pub. Date: Mar. 12, 2009

(54) Non-aqueous electrolyte secondary battery

(76) Inventors: Koji Hasumi, Saitama-shi (JP); Hiroyuki Akita, Kobe-shi (JP); Hironori Shirakata, Osaka (JP); Yoshinori Kida, Osaka (JP); Toshikazu Yoshida, Osaka (JP); Kazunori Donoue, Osaka (JP); Takashi Yamamoto, Osaka (JP); Tetsuyuki Murata, Osaka (JP); Shigeki Matsuta, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/230,123

(22) Filed: Aug. 22, 2008

(30) Foreign Application Priority Data
Aug. 23, 2007 (JP) 2007-216560

(51) Int. Cl. H01M 4/58

(52) U.S. Cl. 429/221; 429/223; 429/224; 429/231.9

(57) ABSTRACT

A non-aqueous electrolyte secondary battery has a negative electrode, a non-aqueous electrolyte, and a positive electrode containing a positive electrode active material composed of an olivine lithium-containing metal phosphate represented by the general formula LiₓMPO₄, where M is at least one element selected from the group consisting of Co, Ni, Mn, and Fe, and 0<x<1.3. The positive electrode active material contains a LiₓMPO₄ aggregate formed by granulating a LiₓMPO₄ having an average particle size of 1 μm or less in a volumetric particle size distribution by coating the LiₓMPO₄ with a binding agent composed of a carbonaceous substance. The LiₓMPO₄ aggregate has an average particle size of 3 μm or less in the volumetric particle size distribution and a 90th percentile particle size (D90) of 7 μm or greater, as measured at the 90th percentile point of the volumetric particle size distribution.

### BACKGROUND OF THE INVENTION

1. Field of the Invention

The present invention relates to a non-aqueous electrolyte secondary battery comprising a positive electrode, a negative electrode, and a non-aqueous electrolyte. More particularly, the invention relates to a non-aqueous electrolyte secondary battery employing a positive electrode active material composed of an olivine lithium-containing metal phosphate represented by the general formula LiₓMPO₄, where M is at least one element selected from the group consisting of Co, Ni, Mn, and Fe, and 0<x<1.3, wherein discharge capability at high current is improved and at the same time storage capability under high temperature conditions is improved.

2. Description of Related Art

In recent years, non-aqueous electrolyte secondary batteries have been widely in use as a new type of high power, high energy density secondary battery. Non-aqueous electrolyte secondary batteries typically use a non-aqueous electrolyte and perform charge-discharge operations by transferring lithium ions between the positive electrode and the negative electrode.

Generally, this type of non-aqueous electrolyte secondary battery often uses lithium cobalt oxide LiCoO₂, spinel lithium manganese oxide LiMn₂O₄, lithium-containing metal composite oxide represented by the general formula LiNiₐCo_{b}Mn_{c}O₂ (wherein a+b+c=1), and the like as the positive electrode active material in the positive electrode.

However, there have been some problems with this type of non-aqueous electrolyte secondary battery. For example, since the positive electrode active material contains scarce natural resources such as cobalt, manufacturing costs tend to be high and it is difficult to ensure a stable supply.

In recent years, the use of an olivine lithium-containing metal phosphate represented by the general formula LiₓMPO₄, where M is at least one element selected from the group consisting of Co, Ni, Mn, and Fe, and 0<x<1.3, has been considered as an alternative to the above-mentioned positive electrode active materials.

The olivine-type lithium-containing phosphate, however, has a very high electrical resistance. A non-aqueous electrolyte secondary battery that uses the olivine-type lithium-containing phosphate as the positive electrode active material in its positive electrode shows a high resistance overvoltage and a low battery voltage when discharged at high current. Therefore, sufficient discharge performance cannot be obtained.

In view of the problem, various proposals have been made in recent years for batteries that employ an olivine lithium-containing metal phosphate as the positive electrode active material. For example, Japanese Published Unexamined Patent Application Nos. 2002-110161, 2002-110162, 2002-110163, 2002-110164, and 2002-110165 propose positive electrode active materials using a composite material of lithium iron phosphate and a carbon material, and positive electrode active materials in which the particle size of the lithium iron phosphate is made smaller to increase the contact area thereof with a conductive agent. Japanese Published Unexamined Patent Application No. 2004-14340 proposes an electrode material employing a lithium-containing phosphate in which secondary particles are formed by a plurality of aggregated primary particles of the lithium-containing phosphate and an electronic conductive substance is interposed between the primary particles.

The discharge capability at high current of the non-aqueous electrolyte secondary battery can be improved in the case in which a composite material of lithium iron phosphate and a carbon material is used as the positive electrode active material, in the case in which the particle size of lithium iron phosphate is reduced to increase the contact area thereof with a conductive agent, and in the case of using an electrode material formed by interposing an electronic conductive substance between primary particles of a lithium-containing phosphate and aggregating a plurality of the primary particles to form aggregated secondary particles. However, when the non-aqueous electrolyte secondary battery is stored under high temperature conditions, the battery capacity deteriorates considerably, which means that the battery has poor storage performance at high temperatures.

### SUMMARY OF THE INVENTION

It is an object of the present invention to solve the foregoing and other problems in a non-aqueous electrolyte secondary battery employing an olivine lithium-containing metal phosphate as a positive electrode active material, so that the discharge capability at high current is improved and at the same time the storage capability under high temperature conditions is improved.

In order to accomplish the foregoing and other objects, the present invention provides a non-aqueous electrolyte secondary battery comprising: a negative electrode; a non-aqueous electrolyte; and a positive electrode containing a positive electrode active material comprising an olivine lithium-containing metal phosphate represented by the general formula LiₓMPO₄, where M is at least one element selected from the group consisting of Co, Ni, Mn, and Fe, and 0<x<1.3; wherein the positive electrode active material comprises a lithium-containing phosphate aggregate formed by granulating a lithium-containing phosphate having an average particle size of 1 μm or less in a volumetric particle size distribution by coating the lithium-containing phosphate with a binding agent comprising a carbonaceous substance, the lithium-containing phosphate aggregate having an average particle size of 3 μm or less in the volumetric particle size distribution and a 90th percentile particle size (D90) of 7 μm or greater, as measured at the 90th percentile point of the volumetric particle size distribution.

In the non-aqueous electrolyte secondary battery of the present invention, the lithium-containing phosphate having an average particle size of 1 μm or less in a volumetric particle size distribution is used as the olivine lithium-containing metal phosphate of the positive electrode active material, which is represented by the general formula LiₓMPO₄, where M is at least one element selected from the group consisting of Co, Ni, Mn, and Fe, and 0<x<1.3. This means that the distance of lithium ion diffusion in the lithium-containing phosphate is short, resulting in good lithium ion diffusion. As a result, the discharge capability at high current is improved.

In the non-aqueous electrolyte secondary battery of the present invention, the lithium-containing phosphate aggregate is formed by granulating the just-mentioned lithium-containing phosphate by coating it with a binding agent comprising a carbonaceous substance. The lithium-containing phosphate aggregate has an average particle size of 3 μm or less in a volumetric particle size distribution, and has a 90th percentile particle size (D90) of 7 μm or greater, as measured at the 90th percentile point of the volumetric particle size distribution. Therefore, it is possible to avoid a decrease in the number of the sites at which electrochemical reactions occur and the associated deterioration of the charge-discharge performance. Thus, when the battery is stored in a charged state under a high temperature condition, the lithium-containing phosphate is prevented from reacting with the non-aqueous electrolyte.

As a result, in the non-aqueous electrolyte secondary battery of the present invention, the discharge capability at high current improves, and at the same time, the storage capability under high temperature conditions also improves. Therefore, the non-aqueous electrolyte secondary battery according to the present invention can suitably be used in applications that require high-rate discharge capabilities, such as power sources for power tools as well as power sources for hybrid electric automobiles and power assisted bicycles.

In the non-aqueous electrolyte secondary battery of the present invention, the cumulative volume of the particles of the lithium-containing phosphate aggregate that have a particle diameter of 3 μm or less in a volumetric particle size distribution may be controlled to be 70% or less of the total volume of the lithium-containing phosphate aggregate. This serves to further improve the storage capability under high temperature conditions.

### BRIEF DESCRIPTION OF THE DRAWINGS

FIG. 1 is a schematic cross-sectional view illustrating a non-aqueous electrolyte secondary battery, as fabricated in Examples 1 and 2 of the present invention as well as Comparative Examples 1 through 3.

### DETAILED DESCRIPTION OF THE INVENTION

A non-aqueous electrolyte secondary battery according to the present invention comprises a negative electrode, a non-aqueous electrolyte, and a positive electrode containing a positive electrode active material comprising an olivine lithium-containing metal phosphate represented by the general formula LiₓMPO₄, where M is at least one element selected from the group consisting of Co, Ni, Mn, and Fe, and 0<x<1.3. The positive electrode active material comprises a lithium-containing phosphate aggregate, formed by granulating a lithium-containing phosphate having an average particle size of 1 μm or less in a volumetric particle size distribution by coating the lithium-containing phosphate with a binding agent comprising a carbonaceous substance. The lithium-containing phosphate aggregate has an average particle size of 3 μm or less in a volumetric particle size distribution and also has a 90th percentile particle size (D90) of 7 μm or greater, as measured at the 90th percentile point of the volumetric particle size distribution. As used herein the volumetric particle size distribution is determined according to the method described in JIS Z8824, JIS Z8825-1 and JIS Z8826.

Here, the lithium-containing phosphate having an average particle size of 1 μm or less in a volumetric particle size distribution is used as the positive electrode active material for the purpose of enhancing the lithium ion dispersibility in the lithium-containing phosphate by shortening the distance of lithium ion diffusion in the lithium-containing phosphate and thereby improving the ionic conductivity in the positive electrode.

The above-described lithium-containing phosphate aggregate formed by granulating the lithium-containing phosphate by coating it with a binding agent comprising a carbonaceous substance may be obtained as follows. For example, the lithium-containing phosphate is immersed in a solution of a hydrocarbon-based compound such as sucrose, and is then dried. Thereafter, the resultant material is sintered to decompose the hydrocarbon-based compound. Thus, the lithium-containing phosphate aggregate can be obtained.

The purpose of controlling the average particle size of the lithium-containing phosphate aggregate in a volumetric particle size distribution to be 3 μm or less is to ensure a sufficient number of sites at which electrochemical reactions occur and thus prevent the charge-discharge performance from deteriorating. The purpose of controlling the 90th percentile particle size (D90) of the lithium-containing phosphate aggregate, as measured at the 90th percentile point of the volumetric particle size distribution, to be 7 μm or greater is to prevent the non-aqueous electrolyte solution used in the non-aqueous electrolyte from reacting with the lithium-containing phosphate when the battery is stored in a charged state under a high temperature, and thereby prevent the resulting deterioration of the storage capability.

It is preferable that, in the non-aqueous electrolyte secondary battery, the cumulative volume of the particles of the lithium-containing phosphate aggregate that have a particle diameter of 3 μm or less, as determined in a volumetric particle size distribution, should be controlled to be 70% or less of the total volume of the lithium-containing phosphate aggregate.

When preparing the positive electrode using the positive electrode active material comprising the lithium-containing phosphate aggregate, it is possible to provide, on a surface of a positive electrode current collector, a positive electrode mixture layer containing the above-described positive electrode active material, a binder agent, and a conductive agent.

Here, generally, the conductive agent used for the positive electrode mixture layer may be a common carbon material. Examples of the carbon material include lumped carbon such as acetylene black and fibrous carbon.

From the viewpoint of improving the conductivity in the positive electrode mixture layer, it is preferable that the amount of the conductive agent in the positive electrode mixture layer be within the range of from 3 weight % to 15 weight %. In particular, from the viewpoint of improving the electron conductivity, it is preferable that the positive electrode mixture layer contain fibrous carbon, such as vapor grown carbon fiber, in an amount of from 5 weight % to 10 weight %.

On the other hand, when the amounts of the conductive agent and the binder agent in the positive electrode mixture layer are too large, a sufficient capacity cannot be obtained since the relative proportion of the positive electrode active material becomes correspondingly small. For this reason, it is preferable that the total content of the conductive agent and the binder agent in the positive electrode mixture layer be 20 weight % or less.

In the non-aqueous electrolyte secondary battery of the present invention, any non-aqueous electrolyte that is commonly used for non-aqueous electrolyte secondary batteries may be used as the non-aqueous electrolyte. For example, it is possible to use a non-aqueous electrolyte solution in which a solute is dissolved in a non-aqueous solvent.

The non-aqueous solvent for the non-aqueous electrolyte may be any non-aqueous solvent that is commonly used for non-aqueous electrolyte secondary batteries. Examples of the non-aqueous solvent include cyclic carbonates such as ethylene carbonate, propylene carbonate, butylene carbonate, and vinylene carbonate; and chain carbonates such as dimethyl carbonate, methyl ethyl carbonate, and diethyl carbonate. A mixed solvent of a cyclic carbonate and a chain carbonate is particularly preferable.

The solute that is to be dissolved in the non-aqueous solvent may also be any solute that is commonly used for non-aqueous electrolyte secondary batteries. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures thereof. In addition to these lithium salts, it is preferable that the non-aqueous electrolyte contain a lithium salt having an oxalato complex as anions. An example of the lithium salt having an oxalato complex as anions is lithium bis(oxalato)borate.

The negative electrode active material used for the negative electrode in the non-aqueous electrolyte secondary battery of the present invention is not particularly limited, but it is preferable that a carbon material be used as the negative electrode active material.

### EXAMPLES

Hereinbelow, examples of the non-aqueous electrolyte secondary battery according to the present invention will be described in detail along with comparative examples. In addition, it will be demonstrated that the non-aqueous electrolyte secondary batteries of the examples according to the invention make it possible to improve discharge capability at high current and at the same time improve storage capability under high temperature conditions, even when an olivine lithium-containing metal phosphate is used as the positive electrode active material. It should be construed that the non-aqueous electrolyte secondary battery according to the present invention is not limited to the following examples, but various changes and modifications are possible without departing from the scope of the invention.

### Example 1

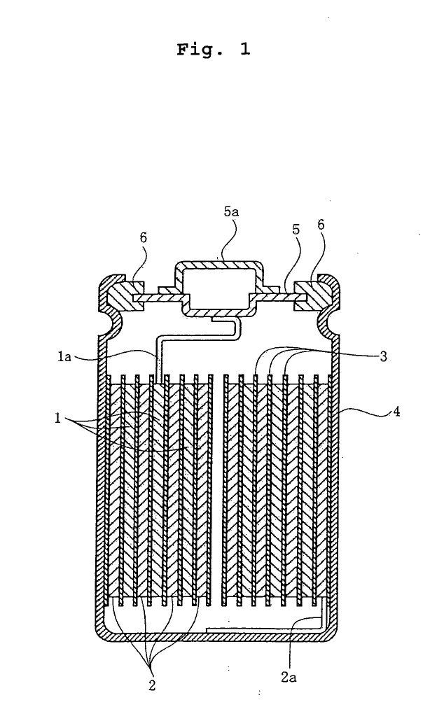

In Example 1, a cylindrical non-aqueous electrolyte secondary battery as illustrated in FIG. 1 having a battery capacity of 1000 mAh was fabricated, using a positive electrode, a negative electrode, and a non-aqueous electrolyte solution that were prepared in the following manner.

### Preparation of Positive Electrode

The positive electrode was prepared in the following manner. First, an olivine-type lithium iron phosphate LiFePO₄ used as the positive electrode active material was obtained as follows. Starting materials, iron phosphate octahydrate Fe₃(PO₄)₂.8H₂O and lithium phosphate Li₃PO₄, were mixed at a mole ratio of 1:1, and the mixture was put into a 10 cm-diameter stainless steel pot, along with 1 cm-diameter stainless steel balls, and kneaded for 12 hours with a planetary ball mill that was operated under the following conditions: radius of revolution: 30 cm, revolution speed: 150 rpm, and rotation speed: 150 rpm. Then, the kneaded material was sintered in an electric furnace in a non-oxidizing atmosphere at 600° C. for 10 hours, then pulverized, and classified. The resultant material was then analyzed using a particle size analyzer (SALD-2000 made by Shimadzu Corp.) with the refractive index being set at 1.50-0.10i. As a result, it was confirmed that the obtained lithium iron phosphate LiFePO₄ had an average particle size of 1 μm or less in volumetric particle size distribution.

Next, the resultant lithium iron phosphate was immersed in a sucrose solution for one hour, and then dried at 110° C. for 2 hours. The sucrose solution was prepared by adding to water with a volumetric ratio of sucrose:water=7:3. Thereafter, the resultant material was sintered in an argon atmosphere at 700° C. for 3 hours. Thus, a lithium iron phosphate aggregate was prepared, which was formed by granulating the lithium iron phosphate by coating the lithium iron phosphate with a binding agent comprising a carbonaceous substance.

The lithium iron phosphate aggregate prepared in this manner was analyzed in the same manner as in the foregoing, using the particle size analyzer. It was found that the lithium iron phosphate aggregate had an average particle size of 0.92 μm in a volumetric particle size distribution and a 90th percentile particle size (D90) of 16.49 μm, as measured at the 90th percentile point of the volumetric particle size distribution. It was also found that the cumulative volume of the lithium iron phosphate aggregate particles having a particle size of 3 μm or less in the volumetric particle size distribution was 70.66% of the total volume of the lithium iron phosphate aggregate.

The positive electrode active material comprising this lithium iron phosphate aggregate, a carbon material as the conductive agent, and an N-methyl-2-pyrrolidone solution in which polyvinylidene fluoride as a binder agent was dissolved were mixed together so that the weight ratio of the positive electrode active material, the conductive agent, and the binder agent was 90:5:5, to thus prepare a positive electrode mixture slurry. The resultant positive electrode mixture slurry was applied onto both sides of a positive electrode current collector made of an aluminum foil and then dried. Thereafter, the resultant material was pressure-rolled with pressure rollers. Thus, a positive electrode in which a positive electrode mixture layer was formed on each side of a positive electrode current collector was prepared, and a positive electrode current collector tab was attached to the positive electrode current collector.

### Preparation of Negative Electrode

The negative electrode was prepared in the following manner. Graphite power as the negative electrode active material and an N-methyl-2-pyrrolidone solution in which polyvinylidene fluoride as a binder agent was dissolved were mixed together so that the weight ratio of the negative electrode active material and the binder agent was 85:15, and the mixture was kneaded together to prepare a negative electrode mixture slurry. The prepared negative electrode mixture slurry was applied onto both sides of a negative electrode current collector made of a copper foil, and then dried. Thereafter, the resultant material was pressure-rolled by pressure rollers. Thus, a negative electrode in which a negative electrode mixture layer was formed on each side of a negative electrode current collector was prepared, and a negative electrode current collector tab was attached to the negative electrode current collector.

### Preparation of Non-Aqueous Electrolyte Solution

The non-aqueous electrolyte solution was prepared as follows. LiPF₆ as a solute was dissolved at a concentration of 1.0 mole/L in a mixed solvent of 3:7 volume ratio of ethylene carbonate and diethyl carbonate, which are non-aqueous solvents.

### Preparation of Battery

The battery was prepared in the following manner. As illustrated in FIG. 1, a separator 3 made of a lithium-ion-permeable, microporous polyethylene film was interposed between the positive electrode 1 and the negative electrode 2 prepared in the above-described manner. These were spirally wound together and enclosed into a battery can 4. A positive electrode current collector tab 1c, provided on the positive electrode 1, was connected to a positive electrode cap 5 on which a positive electrode external terminal 5a was provided. A negative electrode current collector tab 2c, provided on the negative electrode 2, was connected to the battery can 4. The battery can 4 was filled with the above-described non-aqueous electrolyte solution and then sealed, and the battery can 4 and the positive electrode cap 5 were electrically isolated by an insulative packing 6.

### Example 2

In Example 2, a lithium iron phosphate LiFePO₄ having an average particle size of 1 μm or less in a volumetric particle size distribution was used when preparing a positive electrode in the manner as described in Example 1, and the conditions for preparing the lithium iron phosphate aggregate were varied.

In Example 2, a non-aqueous electrolyte secondary battery was prepared in the same manner as described in Example 1 above, except for using a lithium iron phosphate aggregate described below. The lithium iron phosphate aggregate had an average particle size of 1.07 μm in a volumetric particle size distribution and a 90th percentile particle size (D90) of 17.48 μm, as measured at the 90th percentile point of the volumetric particle size distribution. The cumulative volume of the lithium iron phosphate aggregate particles having a particle size of 3 μm or less in the volumetric particle size distribution was 60.58% of the total volume of the lithium iron phosphate aggregate.

### Comparative Example 1

In Comparative Example 1, a lithium iron phosphate LiFePO₄ having an average particle size of 1 μm or less in a volumetric particle size distribution was used when preparing a positive electrode in the manner as described in Example 1, and the conditions for preparing the lithium iron phosphate aggregate were varied.

In Comparative Example 1, a non-aqueous electrolyte secondary battery was prepared in the same manner as described in Example 1 above, except for using a lithium iron phosphate aggregate described below. The lithium iron phosphate aggregate had an average particle size of 0.78 μm in the volumetric particle size distribution and a 90th percentile particle size (D90) of 6.62 μm, as measured at the 90th percentile point of the volumetric particle size distribution. The cumulative volume of the lithium iron phosphate aggregate particles having a particle size of 3 μm or less in the volumetric particle size distribution was 75.34% of the total volume of the lithium iron phosphate aggregate.

### Comparative Example 2

In Comparative Example 2, a lithium iron phosphate LiFePO₄ having an average particle size of 1 μm or less in a volumetric particle size distribution was used when preparing a positive electrode in the manner as described in Example 1, and the conditions for preparing the lithium iron phosphate aggregate were varied.

In Comparative Example 2, a non-aqueous electrolyte secondary battery was prepared in the same manner as described in Example 1 above, except for using a lithium iron phosphate aggregate described below. The lithium iron phosphate aggregate had an average particle size of 4.03 μm in a volumetric particle size distribution and a 90th percentile particle size (D90) of 8.01 μm, as measured at the 90th percentile point of the volumetric particle size distribution.

### Comparative Example 3

In Comparative Example 3, the conditions for preparing the lithium iron phosphate LiFePO₄ and the lithium iron phosphate aggregate were varied when preparing a positive electrode in the manner as described in Example 1.

In Comparative Example 3, a non-aqueous electrolyte secondary battery was prepared in the same manner as described in Example 1 above, except for using a lithium iron phosphate aggregate prepared in the following manner. The lithium iron phosphate aggregate was prepared using a lithium iron phosphate LiFePO₄ having an average particle size of 1.4 μm in a volumetric particle size distribution, and the resulting lithium iron phosphate aggregate had an average particle size of 1.64 μm in the volumetric particle size distribution.

The non-aqueous electrolyte secondary batteries of Examples 1 to 2 as well as Comparative Examples 1 through 3 fabricated in the above-described manners were subjected to a charge-discharge process at room temperature as follows. Each of the batteries was charged at a constant current of 1 A to 3.8 V and thereafter rested for 10 minutes. Thereafter, each of the batteries was discharged at a constant current of 1 A to 2.0 V. This charge-discharge cycle was repeated 5 times, to stabilize the non-aqueous electrolyte secondary batteries.

When the non-aqueous electrolyte secondary batteries were stabilized by the 5-cycle charge-discharge process, the non-aqueous electrolyte secondary battery of Comparative Example 3, which employed the lithium iron phosphate having an average particle size of 1.4 μm in the volumetric particle size distribution, did not yield a sufficient discharge capacity, because the lithium iron phosphate had too large a particle size and sufficient lithium ion diffusion did not take place. For this reason, the later-described evaluations of high rate discharge capability and high temperature storage capability were not performed for the non-aqueous electrolyte secondary battery of Comparative Example 3.

A high rate discharge capability was determined for each of the non-aqueous electrolyte secondary batteries of Examples 1 and 2 and Comparative Examples 1 and 2 in the following manner. At room temperature, each of the batteries was charged at a constant current of 1 A to 3.8 V, then rested for 10 minutes, and thereafter discharged at a constant current of 0.2 A to 2.0 V, to obtain a discharge capacity Q_{0.2A} for each of the batteries. Next, at room temperature, each non-aqueous electrolyte secondary battery was charged at a constant current of 1 A to 3.8 V, then rested for 10 minutes, and thereafter discharged at a constant current of 8 A to V, to obtain a discharge capacity Q_{8A} for each of the batteries.

High rate discharge capability (%) for each of the batteries was obtained as the ratio of discharge capacity Q_{8A} at a 8 A discharge to discharge capacity Q_{0.2A} at a 0.2 A discharge, as shown in the following equation. The results are shown in Table 1 below.

High rate discharge capability (%)=(Q_{8A}/Q_{0.2A})×100

Next, high temperature storage capability was determined for each of the non-aqueous electrolyte secondary batteries of Examples 1 and 2 and Comparative Example 1, which showed a large high rate discharge capability, in the following manner. At room temperature, each of the batteries was charged at a constant current of 1 A to 3.8 V and thereafter discharged at a constant current of 1 A to 2.0 V, to obtain a discharge capacity Q₀ before storage for each of the batteries. Next, at room temperature, each non-aqueous electrolyte secondary battery was charged at a constant current of 1 A to 3.8 V. Then, each of the batteries in a charged state was stored under a high temperature condition at 60° C. for 20 days. Thereafter, each of the batteries was discharged at a constant current of 1 A to 2.0 V, to obtain a discharge capacity Qₐ after high-temperature storage for each of the batteries.

For each of the non-aqueous electrolyte secondary batteries, capacity retention ratio (%) after the high temperature storage was determined by the following equation.

Capacity retention ratio=(Qa/Qo)×100.

The high temperature storage capability of each of the non-aqueous electrolyte secondary batteries of Examples 1 and 2 and Comparative Example 1 was calculated as an index number with respect to the capacity retention ratio for the non-aqueous electrolyte secondary battery of Example 1, which was taken as 100. The results are shown in Table 1 below.

TABLE 1

| | | LiFePO₄ aggregate | | | | |
|---|---|---|---|---|---|---|
| | Average | Aver- | | Proportion of | | High |
| | particle | age | | particles | | temper- |
| | size of | par- | | with a parti- | High rate | ature |
| | LiFePO₄ | ticle | | cle size of | discharge | storage |
| | particles | size | D₉₀ | 3 μm or less | capability | capability |
| Ex. 1 | 1 μm or | 0.92 | 16.49 | 70.66% | 83% | 100 |
| | less | μm | μm | | | |
| Ex. 2 | 1 μm or | 1.07 | 17.48 | 60.58% | 86% | 103 |
| | less | μm | μm | | | |
| Comp. | 1 μm or | 0.78 | 6.62 | 75.34% | 88% | 86 |
| Ex. 1 | less | μm | μm | | | |
| Comp. | 1 μm or | 4.03 | 8.01 | — | 73% | — |
| Ex. 2 | less | μm | μm | | | |
| Comp. | 1.4 μm | 1.64 | — | — | — | — |
| Ex. 3 | | μm | | | | |

The results are as follows. The non-aqueous electrolyte secondary batteries of Examples 1 and 2 and Comparative Examples 1 and 2 are compared, each of which employs a positive electrode comprising a lithium iron phosphate aggregate prepared using a lithium iron phosphate having an average particle size of 1 μm or less in a volumetric particle size distribution. The non-aqueous electrolyte secondary battery of Comparative Example 2, which employed the lithium iron phosphate aggregate having an average particle size of 4.03 μm in the volumetric particle size distribution showed a considerably lower high rate discharge capability than the non-aqueous electrolyte secondary batteries of Examples 1 and 2 and Comparative Example 1. This is believed to be because the lithium iron phosphate aggregate used in Comparative Example 2 had a large particle size and therefore migration of lithium ions did not take place smoothly.

The non-aqueous electrolyte secondary batteries of Examples 1 and 2 and Comparative Example 1 are compared. Although the differences in high rate discharge capability were small between these batteries, the non-aqueous electrolyte secondary battery of Comparative Example 1, which employed the lithium iron phosphate aggregate having a 90th percentile particle size (D90) of 6.62 μm, showed a considerably lower high temperature storage capability than the non-aqueous electrolyte secondary batteries of Examples 1 and 2, which employed the lithium iron phosphate aggregate having a 90th percentile particle size (D90) of 7 μm or greater. This is believed to be because the non-aqueous electrolyte solution infiltrated into the lithium iron phosphate aggregate and reacted with the lithium iron phosphate during the storage at the high temperature.

The non-aqueous electrolyte secondary batteries of Examples 1 and 2 are compared. The non-aqueous electrolyte secondary battery of Example 2, in which the cumulative volume of the lithium-containing phosphate aggregate particles having a particle size of 3 μm or less in the volumetric particle size distribution was 70% or less of the total volume of the lithium-containing phosphate aggregate particles, exhibited further improved high rate discharge capability and high temperature storage capability over the non-aqueous electrolyte secondary battery of Example 1, in which the cumulative volume of the lithium-containing phosphate aggregate particles having a particle size of 3 μm or less in the volumetric particle size distribution was greater than 70% of the total volume of the lithium-containing phosphate aggregate particles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A non-aqueous electrolyte secondary battery comprising: a negative electrode; a non-aqueous electrolyte; and a positive electrode containing a positive electrode active material comprising an olivine lithium-containing metal phosphate represented by the general formula LiₓMPO₄, where M is at least one element selected from the group consisting of Co, Ni, Mn, and Fe, and 0<x<1.3; wherein the positive electrode active material comprises a lithium-containing phosphate aggregate formed by granulating a lithium-containing phosphate having an average particle size of 1 μm or less in a volumetric particle size distribution by coating the lithium-containing phosphate with a binding agent comprising a carbonaceous substance, the lithium-containing phosphate aggregate having an average particle size of 3 μm or less in the volumetric particle size distribution and a 90th percentile particle size (D90) of 7 μm or greater, as measured at the 90th percentile point of the volumetric particle size distribution.

2. The non-aqueous electrolyte secondary battery according to claim 1, wherein the cumulative volume of the particles of the lithium-containing phosphate aggregate that have a particle diameter of 3 μm or less, as determined in the volumetric particle size distribution, is 70% or less of the total volume of the lithium-containing phosphate aggregate.
